(19) United States
(12) Patent Application Publication
(10) Pub. No.: US 2021/0168701 A1
(43) Pub. Date: Jun. 3, 2021

(54) INTERLEAVED DEEP AND SHALLOW SEARCH DURING FREQUENCY SCAN FOR RADIO RESOURCES

(71) Applicant: QUALCOMM Incorporated, San Diego, CA (US)

(72) Inventors: Yongle WU, San Diego, CA (US); Satashu GOEL, San Diego, CA (US); Arvind Vardarajan SANTHANAM, San Diego, CA (US); Chinmay Shankar VAZE, San Diego, CA (US); Alexei Yurievitch GOROKHOV, San Diego, CA (US); Brian Clarke BANISTER, San Diego, CA (US); Daniel AMERGA, San Diego, CA (US); Huan XU, San Diego, CA (US)

(21) Appl. No.: 17/105,430

(22) Filed: Nov. 25, 2020

Related U.S. Application Data
(60) Provisional application No. 62/942,050, filed on Nov. 29, 2019.

(51) Int. Cl. H04W 48/16; H04B 17/336

(52) U.S. Cl. CPC H04W 48/16; H04W 84/042; H04B 17/336

(57) ABSTRACT

A cell acquisition technique for 5G and other RATs is provided in which shallow scans are interleaved with deep scans. In each shallow scan, a UE determines whether a synchronization signal is received with sufficient signal quality over one period for the synchronization signal. In each deep scan, the UE determines whether the synchronization signal is received with sufficient signal quality over multiple periods for the synchronization signal.

### CROSS REFERENCE TO RELATED APPLICATION

The present application claims priority to U.S. Provisional Patent Application No. 62/942,050, filed Nov. 29, 2019, which is hereby incorporated by reference in its entirety.

### TECHNICAL FIELD

This application relates to wireless communication systems, and more particularly to the acquisition of radio resources with interleaved deep and shallow searches during a frequency scan.

### INTRODUCTION

To meet the growing demands for expanded mobile broadband connectivity, wireless communication technologies have advanced from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

Unlike LTE, there are no persistent wideband signals in NR like LTE's cell specific reference signals. To search for a cell using a certain frequency band, an NR user equipment (UE) scans across the frequency band at various frequencies of a synchronization raster for the frequency band. Cell search and the associated frequency scan may occur in response to a number of events such as a power-up of the UE or a mobility failure recovery for the UE. The delay from the frequency scan is a critical factor that may impact user experience.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication is provided that includes: performing a first shallow scan at a user equipment (UE) over a frequency band by determining at each frequency of a synchronization raster for the frequency band whether a synchronization signal is received over a repetition period for the synchronization signal with a first signal quality sufficient to permit synchronization with a base station; and in response to the first shallow scan not being successful, performing a deep scan over the frequency band by determining at each frequency of the synchronization raster for the frequency band whether the synchronization signal is received over a series of repetition periods for the synchronization signal with a second signal quality sufficient to permit synchronization the base station

In an additional aspect of the disclosure, a UE is provided that includes: a transceiver configured to: perform a first shallow scan over a frequency band by a determination at each frequency of a synchronization raster for the frequency band of whether a synchronization signal is received over a repetition period for the synchronization signal with a first signal quality to permit synchronization with downlink transmissions from a base station; and in response to the first shallow scan not being successful, perform a deep scan over the frequency band by a determination at each frequency of the synchronization raster of whether the synchronization signal is received over a series of repetition periods for the synchronization signal with a second signal quality to permit synchronization with the base station.

Finally, a method of wireless communication is provided that includes: incrementing a count; responsive to the count being equal to a first integer, accumulating a received signal quality over multiple synchronization signal periods at each frequency of a synchronization raster to form an accumulated signal quality for each frequency; determining if the accumulated signal quality for each frequency exceeds a first threshold to determine whether a synchronization signal is successfully detected at the frequency; responsive to the count not being equal to the first integer, determining a received signal quality for an additional synchronization period at each frequency of a synchronization raster to form a received signal quality for each frequency; and determining if the received signal quality for each frequency exceeds a second threshold to determine whether the synchronization signal is successfully detected at the frequency.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system with enhanced frequency scanning in accordance with an aspect of the disclosure.

FIG. 2 is a schematic illustration of an organization of wireless resources utilizing orthogonal frequency divisional multiplexing (OFDM) for the wireless communication system of FIG. 1.

FIG. 3 illustrates a synchronization signal block (SSB) for a base station in the system of FIG. 1.

FIG. 4A is a plot for an initial interleaved shallow/deep frequency scan in accordance with an aspect of the disclosure.

FIG. 4B is a plot for a BPLMN frequency scan in accordance with an aspect of the disclosure.

FIG. 4C is a plot for an additional interleaved shallow/deep frequency scan in accordance with an aspect of the disclosure.

FIG. 5 illustrates an architecture for a user equipment in the system of FIG. 1 in accordance with an aspect of the disclosure.

FIG. 6 is a flowchart for an example method of frequency scanning in accordance with an aspect of the disclosure.

### DETAILED DESCRIPTION

An interleaved frequency scan is disclosed that offers an advantageous balance between performance and delay (the amount of time necessary for a successful frequency scan). To provide a better appreciation of this enhanced frequency scanning, some background principles for NR will be reviewed initially and followed by a detailed discussion of the enhanced frequency scanning. The various concepts presented throughout this disclosure may be implemented across a broad variety of telecommunication systems, network architectures, and communication standards.

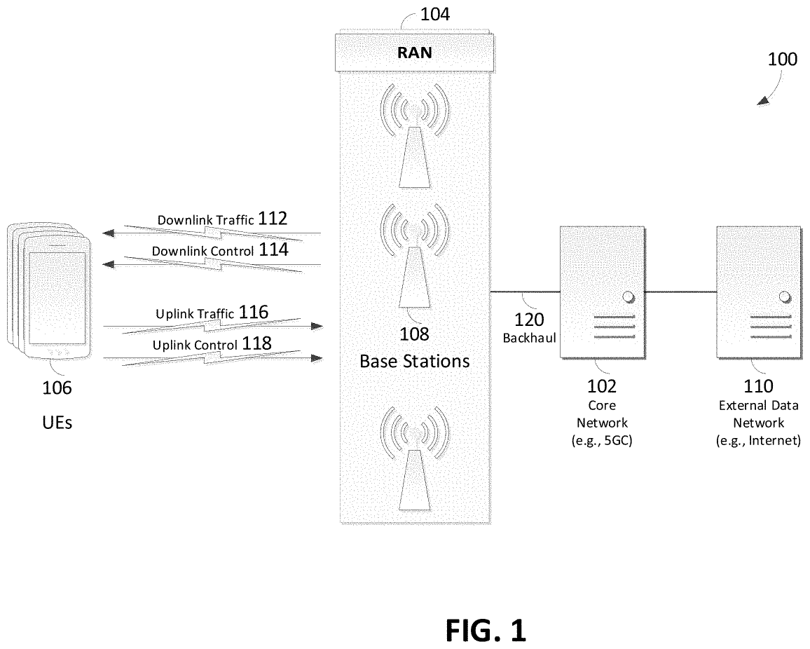

Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a plurality of user equipment (UE) 106. By virtue of the wireless communication system 100, each UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE 106. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services.

Within the present document, a “mobile” apparatus need not necessarily have a capability to move and may be stationary. The term mobile apparatus or mobile device broadly refers to a diverse array of devices and technologies. UEs 106 may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs 106 may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE 106.

As illustrated in FIG. 1, a base station 108 may broadcast downlink traffic 112 to one or more UEs 106. Broadly, the base station 108 is a node or device responsible for scheduling traffic in a wireless communication network, including the downlink traffic 112 and, in some examples, uplink traffic 116 from the one or more UEs 106. On the other hand, each UE 106 is a node or device that receives downlink control information 114, including but not limited to scheduling information (e.g., a grant), synchronization or timing information, or other control information from another entity in the wireless communication network such as the base station 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

In various implementations, the air interface in the radio access network 104 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The air interface in the radio access network 104 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at one time the channel is dedicated for transmissions in one direction, while at other times the channel is dedicated for transmissions in the other direction, where the direction may change very rapidly, e.g., several times per slot.

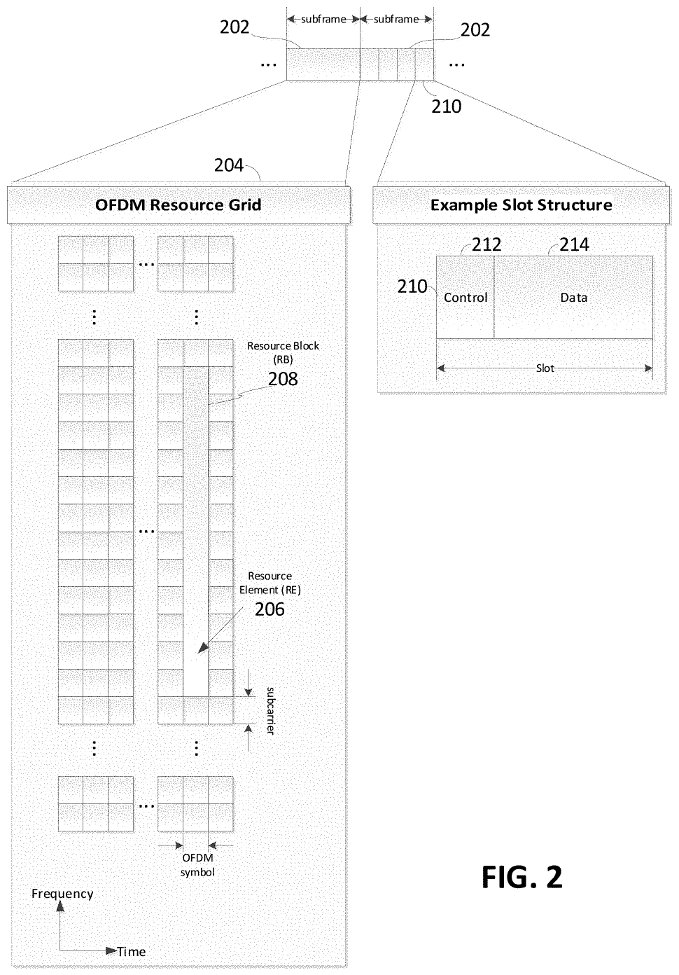

Various aspects of the present disclosure will be described with reference to an OFDM waveform, schematically illustrated in FIG. 2. Within the present disclosure, a frame refers to a duration of 10 ms for wireless transmissions, with each frame consisting of 10 subframes of 1 ms each. On a given carrier, there may be one set of frames in the UL, and another set of frames in the DL. An expanded view of an exemplary DL subframe 202 is also illustrated in FIG. 2, showing an OFDM resource grid 204. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers or tones.

The resource grid 204 may be used to schematically represent time-frequency resources for a given antenna port. That is, in a MIMO implementation with multiple antenna ports available, a corresponding multiple number of resource grids 204 may be available for communication. The resource grid 204 is divided into multiple resource elements (REs) 206. An RE, which is 1 subcarrier×1 symbol, is the smallest discrete part of the time-frequency grid, and contains a single complex value representing data from a physical channel or signal. A block of twelve consecutive subcarriers defined a resource block (RB) 208, which has an undefined time duration in the NR standard. In FIG. 2, resource block 208 extends over a symbol duration. Within the present disclosure, it is assumed that a single RB such as the RB 208 entirely corresponds to a single direction of communication (either transmission or reception for a given device). A set of contiguous RBs 208 such as shown for resource grid 204 form a bandwidth part (BWP).

A UE generally utilizes only a subset of the resource grid 204. An RB may be the smallest unit of resources that can be allocated to a UE. Thus, the more RBs scheduled for a UE, and the higher the modulation scheme chosen for the air interface, the higher the data rate for the

UE.

In FIG. 2, the RB 208 is shown as occupying less than the entire bandwidth of the subframe 202, with some subcarriers illustrated above and below the RB 208. In a given implementation, the subframe 202 may have a bandwidth corresponding to any number of one or more RBs 208. Further, in this illustration, the RB 208 is shown as occupying less than the entire duration of the subframe 202, although this is merely one possible example.

Each 1 ms subframe 202 may consist of one or multiple adjacent slots. In the example shown in FIG. 2, one subframe 202 includes four slots 210, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., one or two OFDM symbols). These mini-slots may in some cases be transmitted occupying resources scheduled for ongoing slot transmissions for the same or for different UEs.

An expanded view of one of the slots 210 illustrates the slot 210 including a control region 212 and a data region 214. In general, the control region 212 may carry control channels (e.g., PDCCH), and the data region 214 may carry data channels (e.g., PDSCH or PUSCH). Of course, a slot may contain all DL, all UL, or at least one DL portion and at least one UL portion. The simple structure illustrated in FIG. 2 is merely exemplary in nature, and different slot structures may be utilized, and may include one or more of each of the control region(s) and data region(s).

Although not illustrated in FIG. 2, the various REs 206 within a RB 208 may be scheduled to carry one or more physical channels, including control channels, shared channels, data channels, etc. Other REs 206 within the RB 208 may also carry pilots or reference signals, including but not limited to a demodulation reference signal (DMRS) a control reference signal (CRS), or a sounding reference signal (SRS). These pilots or reference signals may provide for a receiving device to perform channel estimation of the corresponding channel, which may enable coherent demodulation/detection of the control and/or data channels within the RB 208.

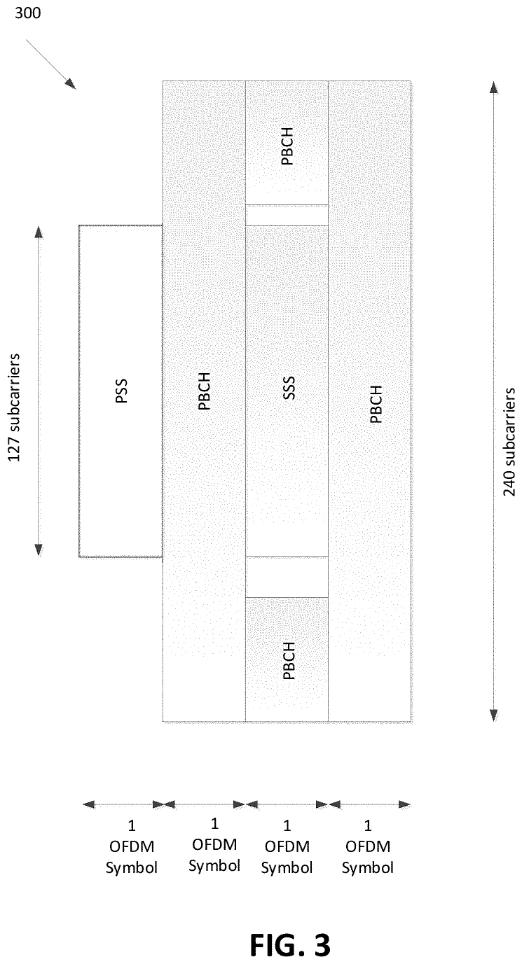

Referring again to FIG. 1, each UE 106 establishes a connection with an appropriate base station 108 through an initial access procedure using the enhanced frequency scan, whereby the UE 106 obtains system information associated with the network. In an NR network, each base station 108 sequentially transmits a synchronization signal block (SSB). An example SSB block 300 is shown in FIG. 3. SSB 300 extends over four OFDM symbols. The available bandwidth for SSB 300 is 240 subcarriers, which is 20 resource blocks. The first OFDM symbol may include a primary synchronization signal (PSS) that extends across 127 subcarriers within the center of the available bandwidth. A physical broadcast channel (PBCH) occupies all 240 subcarriers in the second OFDM symbol. A secondary synchronization signal (SSS) occupies the center 127 subcarriers within the third OFDM signal. If the 240-subcarrier bandwidth for SSB 300 is deemed to extend from a first resource block to a twentieth resource block, the PBCH occupies the first 4 resource blocks and the final four resource blocks in the third OFDM symbol. The PBCH also occupies all 240 subcarriers in the fourth OFDM symbol. The PBCH provides system information including a master information block (MIB). The MIB identifies parameters so that each corresponding UE 106 in a footprint (within the cell coverage) of a base station 108 may acquire a first SIB (SIB1). The SIB1 (not illustrated) contains information on the scheduling of other SIBs. In some implementations, a SIB such as SIB1 provides a transmit power adjustment command for a UE 106 to adjust the transmit power it uses to transmit its uplink messages.

Each base station 108 periodically transmits a burst of SSBs, each SSB being assigned to a specific antenna beam. For example, if a base station 108 has N antenna beams, there would be N different SSBs uniquely assigned to the N corresponding antenna beams. If the beams are deemed to be numbered from one to N, the corresponding SSBs may be numbered accordingly to range from an SSB1 to an SSBN. In such an implementation, the SSB burst would be the N SSBs. The maximum value for the integer N depends upon the frequency band. For example, below 3 GHz, there can be up to four antenna beams and corresponding SSBs. The integer N is increased for higher frequency bands such as up to 64 for the FR2 frequency band. In an SSB, the PBCH provides a block time index that identifies the relative location of the SSB within an SSB burst. From an SSB, a UE 106 receives the information necessary to acquire the corresponding SIB1 that in turn provides the UE 106 with the information necessary to carry out an initial random-access (the initial access procedure) to the corresponding base station 108.

Given this introduction, some exemplary implementations for an enhanced frequency scan will now be discussed in more detail. The following discussion will be directed to the system acquisition by a UE 106 of a standalone NR cell. However, it will be appreciated that the system acquisition discussed herein is applicable to any suitable RAT. As used herein, the terms “system acquisition” and “cell acquisition” are used interchangeably. To acquire a cell, a UE 106 synchronizes itself to the symbol boundaries in the downlink transmissions from the base station 108 to the UE 106. In addition, the UE 106 synchronizes itself as to the specific carrier frequency used by the base station 108 for the downlink communication.

Since the UE 106 does not know a priori what carrier frequency is being used by the base station within a given frequency band, it is conventional for the UE 106 to scan a frequency band according to the synchronization raster for the frequency band as defined by the 3GPP organization. The synchronization raster for a frequency band identifies the frequency positions of potential SSBs in the frequency band. These frequency positions vary from frequency band to frequency band and are identified by a frequency band's synchronization raster. In a standalone NR system, the UE 106 has no explicit signaling that identifies to the UE the frequency position of the SSBs from a base station 108. In contrast, a UE 106 in a EUTRA-NR system is informed by the network such as through a RRC reconfiguration message the frequency used by the base station 108. The UE 106 in a standalone NR system has only the synchronization raster and must thus scan for the SSBs to acquire a cell (synchronize with the base station's downlink channel).

There are at least two ways a UE 106 may scan for the SSBs. In a full frequency scan (FFS), the UE 106 scans each frequency within a frequency band as specified by the synchronization raster for the scanned frequency band. Alternatively, the UE 106 may perform a more limited scan (denoted as a list frequency scan) of certain frequencies within the scanned frequency band. A list frequency scan (LFS) is thus a subset of the frequencies specified in the synchronization raster for a given frequency band. The frequencies specified in an LFS scan would typically be known good rasters that the UE 106 has reason to believe would be utilized by base stations 108 in the vicinity of the UE.

The number of global synchronization channel number (GSCN) rasters within a synchronization raster may be rather large. For example, there are 341 candidate rasters in band n78 for a standalone NR system. The frequency scan time for NR may thus be substantial and impact the user experience. To provide improved cell acquisition times, an enhanced (interleaved) frequency scan technique is disclosed herein. The interleaving concerns the number of SSBs used or sampled by the UE 106 for a given candidate raster for the corresponding frequency band's synchronization raster.

The scan technique disclosed herein is applicable to single beam base stations 108 as well as multiple-beam base stations 108. Regardless of the number of beams used by the base station 108, each beam has a corresponding SSB that is repeated every 20 ms. In what is denoted herein as a deep scan, a UE 106 accumulates a signal quality parameter such as the signal-to-noise ratio (SNR) or a log likelihood ratio (LLR) for multiple SSBs in the same beam. Should a base station 108 have only one antenna beam, there would then be only one type of SSB that is repeated every 20 ms in the single beam. If a base station 108 has multiple antenna beams, the deep scan would be across multiple SSBs for each beam. A deep scan is useful in weak signal environments in which a detected SSB may actually be derived from noise and thus not correspond to an actual SSB. But due to the random nature of noise, it would be unlikely that such a false SSB detection would have approximately the same SNR across a series of such false SSBs. On the other hand, the SNR for a weak but actual SSB will tend to be the same across a series of such real SSBs. By adding the SNRs for such consecutive SSBs and comparing the sum to a suitable threshold, a UE 106 performing a deep scan may thus expect that the accumulated SNR would increase by 6 dB as compared to the SNR for each individual SSB. The sum (the accumulated SNRs) may then be compared to the suitable threshold. If the accumulated SNR exceeds the threshold, the detected SSBs are deemed to be legitimate and the UE 108 may then proceed with the synchronization so as to acquire the cell accordingly.

A second scan technique that may be interleaved with the deep scan is denoted herein as a shallow scan. In a shallow scan, the UE uses just one SSB (or a series of SSBs that is fewer than the series used in a deep scan) and makes a decision based upon its signal quality (e.g, its SNR) whether or not the SSB is trustworthy or not.

In both types of scans, the signal quality measurement for the SSB may be of the PSS, the SSS, the PHCH signal, or some sub-combination or combination of these signals. For example, the signal quality measurement may be of the demodulation reference signal (DMRS) in the PBCH in some embodiments.

The interleaving of the scans depends upon whether the UE is roaming or within a home NR network. This roaming may be to another service provider's NR network or other suitable RATs such as LTE. If the UE assumes it is in a home network, an interleaved frequency scan may be triggered at power-up or in response to a mobility failure. The interleaving may be 1 deep scan for every N scans. There are thus N-1 shallow scans that may be interleaved with every deep scan. For example, in one embodiment, N equals four. To keep track of the scans, the UE may then leverage an existing counter such as an existing non-access stratum (NAS) counter. Alternatively, a dedicated counter may be used for the interleaved frequency scans. The scanning begins after power-up of the UE 106 or after mobility failures such as a radio link failure (RLF) or an out-of-synchronization (OOS) failure. In one embodiment, the initial scan is a shallow scan so that if a received SSB is relatively-strong the UE 106 will acquire the corresponding cell quickly. If the SSB is not detected or is too weak to be deemed reliable, the subsequent scan is a deep scan so that the resulting integration of relatively-weak SSBs may still lead to a cell acquisition. The remaining scans in the series of N scans may then be shallow scans. In an embodiment in which N equals four, the resulting interleaving would be shallow, deep, shallow, and shallow for the four scans. It will be appreciated, however, that the number of deep scans that are interleaved with shallow scans in a series of N scans may be varied from one in alternative embodiments. Similarly, the positioning of the at least one deep scan in the series of N scans may be varied in alternative embodiments. In an embodiment in which N equals four and the deep scan positioning is the second scan, a radio resource control (RRC) layer in the UE may monitor a modulo-N counter (e.g., a modulo-4 counter) such as the NAS counter to determine the scan type such that the default scan is a shallow scan unless the count is 2. More generally, if the count equals a positive integer X, the RRC layer may command for a deep scan, where 1≤X≤N. For any other value of the count besides X, the RRC layer may command for a shallow scan. The appropriate scan (deep or shallow) may then be carried by a physical layer software element such as ML1.

The interleaved frequency scanning discussed herein occurs when a UE 106 is not camped on any cell such as following power-up of the UE or from a mobility failure. But there are frequency scans that may occur when the UE has acquired a cell. For example, a roaming UE 106 may conduct a scan for its home network. Since this scan occurs in the background while the UE 106 has acquired a cell in the roaming network, the resulting frequency scan for its home network may be denoted as a background public land mobile network (BPLMN) scan. For a BPLMN scan, the default scan may be dedicated solely to a shallow scan as finding a relatively-weak home network in a roaming scenario may not be beneficial. A manual public land mobile network (MPLMN) scan is a user-initiated search that is either initiated by the user or by an application in a UE 106 for non-roaming scenarios. For an MPLMN scan, the default scan may be a deep scan to allow for the acquisition of relatively-weak cells

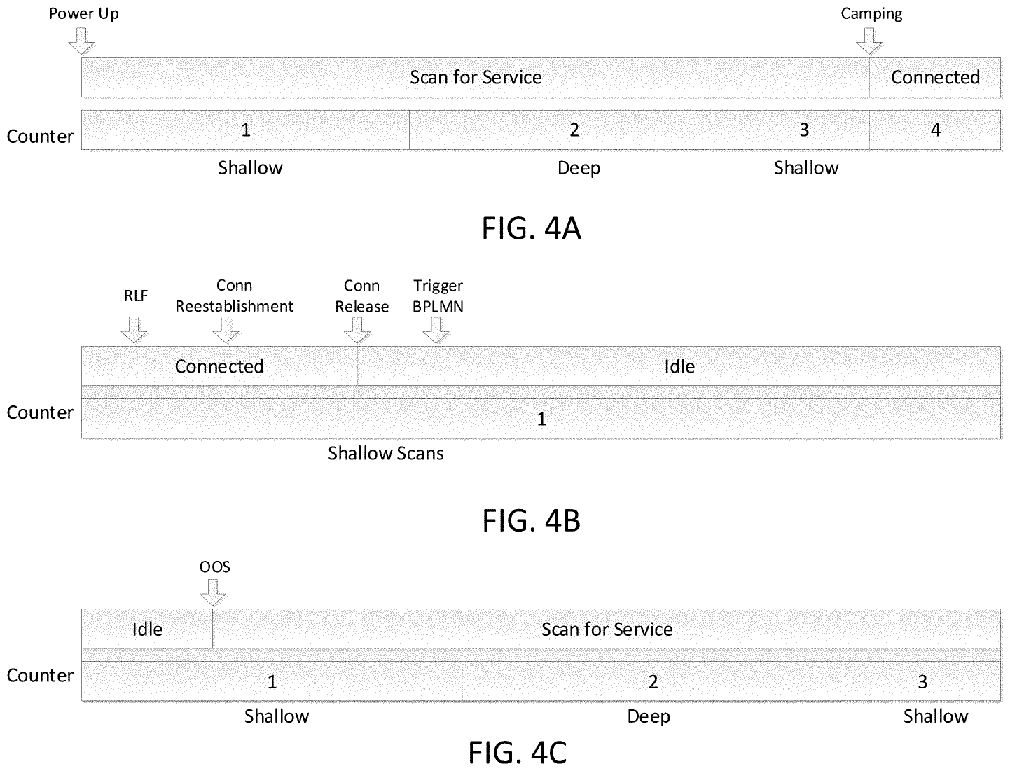

Regardless of whether the scan is an interleaved frequency scan or a BPLMN/MPLMN scan, the selection of a shallow scan or a deep scan may be performed by the RRC layer. The RRC layer may then pass the scan type decision to a software layer in a UE 106 for its implementation. Some example scans will now be discussed beginning with FIG. 4A, which illustrates an interleaved scan following power up of the UE 106. The initial scan is a shallow scan as controlled by the NAS scan count being one. The shallow scan would extend across all the rasters for a full frequency scan but may be interleaved with list frequency scans as discussed earlier. Should the initial shallow scan be unsuccessful despite scanning all the rasters, the NAS count increments to two so that the second scan is a deep scan. The deep scan may also be a full frequency scan that is interleaved with list frequency scans. Note that both the shallow scan and the deep scans may also involve scans for alternative RATs. Should the deep scan be unsuccessful, the NAS counter increments to three so that another shallow scan in initiated. In this example, this additional shallow scan is successful so that the NAS counter is decremented to one and the UE 106 begins to camp on the acquired cell.

While the UE 106 is camped on the acquired cell, it may have a radio link failure (RLF) as shown in FIG. 4B. A shallow scan is then initiated since the count equals 1. This initial shallow scan results in a connection (Conn) reestablishment. The UE 106 may then enter an idle mode so that the connection is released. A BPLMN scan may then be triggered. Note that the NAS counter is not incremented for the BPLMN scan, which may be a series of shallow scans as noted earlier.

The UE 106 may then move out of a coverage area during an idle state and enter an out-of-synchronization (OOS) state as shown in FIG. 4C. An interleaved frequency scan then ensues. An initial scan is a shallow scan since the count equals one for this initial scan. If the scan is unsuccessful, the counter is incremented to equal two such that a deep scan is triggered. If the deep scan is unsuccessful, the counter is incremented to equal three so that a shallow scan is triggered.

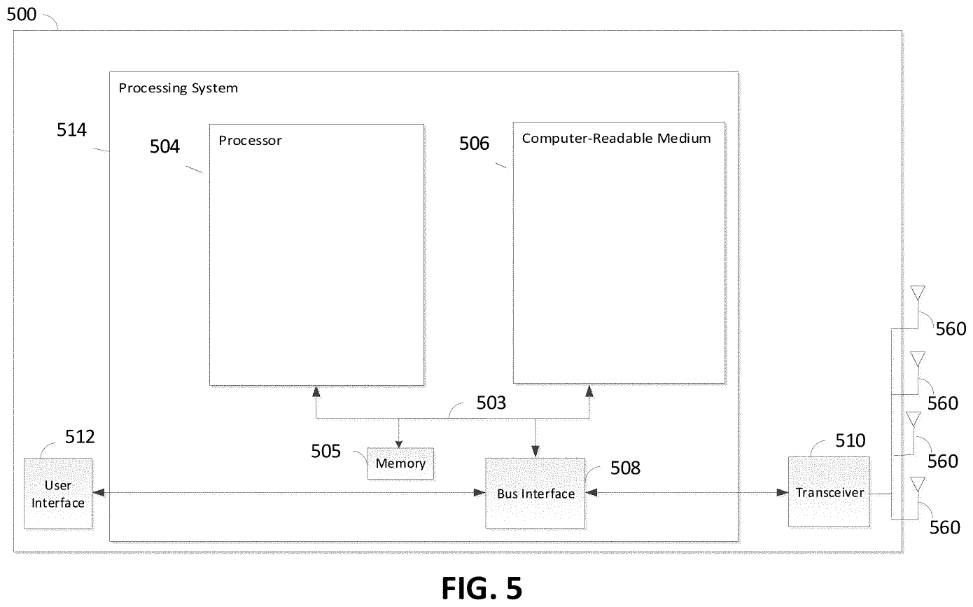

An example user equipment 500 for the enhanced frequency scanning disclosed herein is shown in FIG. 5. UE 500 includes a processing system 514 having a bus interface 508, a bus 502, memory 505, a processor 504, and a computer-readable medium 506. Furthermore, UE 500 may include a user interface 512 and a transceiver 510. Transceiver 510 transmits and receives through an array of antennas 560.

Processor 504 is also responsible for managing the bus 502 and general processing, including the execution of software stored on the computer-readable medium 506. The software, when executed by the processor 504, causes the UE 500 to perform the enhanced frequency scanning disclosed herein. The counter such as a NAS counter may be implemented by logic executed by processor 504. The computer-readable medium 506 and the memory 505 may also be used for storing data that is manipulated by the processor 504 when executing software.

The bus 502 may include any number of interconnecting buses and bridges depending on the specific application of the processing system 514 and the overall design constraints. The bus 502 communicatively couples together various circuits including one or more processors (represented generally by the processor 504), the memory 505, and computer-readable media (represented generally by the computer-readable medium 506). The bus 502 may also link various other circuits such as timing sources, peripherals, voltage regulators, and power management circuits, which are well known in the art, and therefore, will not be described any further. The bus interface 508 provides an interface between the bus 502 and the transceiver 510. The transceiver 510 provides a communication interface or means for communicating with various other apparatus over a transmission medium. Depending upon the nature of the apparatus, a user interface 512 (e.g., keypad, display, speaker, microphone, joystick) may also be provided.

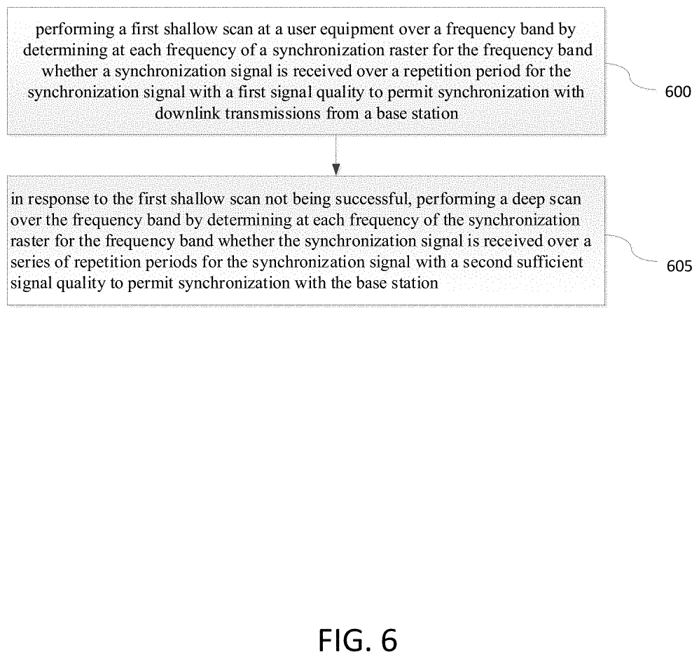

A method of frequency scanning will now be discussed with reference to the flowchart of FIG. 6. The method includes an act 600 of performing a first shallow scan at a user equipment (UE) over a frequency band by determining at each frequency of a synchronization raster for the frequency band whether a synchronization signal is received over a repetition period for the synchronization signal with a first signal quality to permit synchronization with downlink transmissions from a base station. The shallow scans discussed with regard to FIG. 4A or 4C are an example of act 600. In addition, the method incudes an act 605 that occurs in response to the first shallow scan not being successful and includes performing a deep scan over the frequency band by determining at each frequency of the synchronization raster for the frequency band whether the synchronization signal is received over a series of repetition periods for the synchronization signal with a second signal quality to permit synchronization with the downlink transmissions from the base station. The deep scans discussed with regard to FIG. 4A or 4C are an example of act 605.

The disclosure will now be summarized in a series of clauses:

Clause 1. A method of wireless communication, comprising:

performing a first shallow scan at a user equipment (UE) over a frequency band by determining at each frequency of a synchronization raster for the frequency band whether a synchronization signal is received over a repetition period for the synchronization signal with a first signal quality to permit synchronization a base station; and in response to the first shallow scan not being successful, performing a deep scan over the frequency band by determining at each frequency of the synchronization raster for the frequency band whether the synchronization signal is received over a series of repetition periods for the synchronization signal with a second signal quality to permit synchronization with the base station.

Clause 2. The method of clause 1, further comprising:

performing a second shallow scan at the user equipment by determining at each frequency of the synchronization raster whether the synchronization signal is received over the repetition period for the synchronization signal with the first sufficient signal quality to permit synchronization with the base station.

Clause 3. The method of clause 2, wherein the second shallow scan is responsive to the deep scan not being successful.
Clause 4. The method of clause 2, wherein the second shallow scan is subsequent to the first shallow scan, and wherein the deep scan is further responsive to the second shallow scan not being successful.
Clause 5. The method of clause 1, wherein the synchronization signal is a synchronization signal block (SSB) for a new radio (NR) system.
Clause 6. The method of any of clauses 1-5, wherein the first sufficient signal quality is a first signal-to-noise ratio, and wherein the second sufficient signal quality is a second signal-to-noise ratio.
Clause 7. The method of clause 6, wherein the first signal-to-noise ratio and the second signal-to-noise ratio are both measures of a primary synchronization signal (PSS) for the SSB.
Clause 8. The method of clause 6, wherein the first signal-to-noise ratio and the second signal-to-noise ratio are both measures of a secondary synchronization signal (SSS) for the SSB.
Clause 9. The method of clause 6, wherein the first signal-to-noise ratio and the second signal-to-noise ratio are both measures of a physical broadcast channel (PBCH) signal for the SSB.
Clause 10. The method of clause 9, wherein both measures are of a demodulation reference signal (DMRS) in the PBCH signal.
Clause 11. The method of any of clauses 1-10, further comprising:

incrementing a count for the first shallow scan and for the deep scan, wherein the first shallow scan is responsive to the count having a first value and wherein the deep scan is further responsive to the count having a second value.

Clause 12. The method of clause 11, wherein incrementing the count comprises incrementing the count in a modulo-N counter.
Clause 13. The method of clause 12, wherein the modulo-N counter is a modulo-4 counter.
Clause 14. The method of clause 13, wherein the deep scan is further responsive to the count for the modulo-4 counter equaling two.
Clause 15. A user equipment (UE), comprising:

a transceiver configured to:

perform a first shallow scan over a frequency band by a determination at each frequency of a synchronization raster for the frequency band of whether a synchronization signal is received over a repetition period for the synchronization signal with a first signal quality sufficient to permit synchronization with downlink transmissions from a base station; and

in response to the first shallow scan not being successful, perform a deep scan over the frequency band by a determination at each frequency of the synchronization raster of whether the synchronization signal is received over a series of repetition periods for the synchronization signal with a second signal quality sufficient to permit synchronization with the downlink transmissions from the base station.

Clause 16. The UE of clause 15, wherein the transceiver is further configured to:

perform a second shallow scan over the frequency band by a determination at each frequency of the synchronization raster of whether the synchronization signal is received over a repetition period for the synchronization signal with the first sufficient signal quality to permit the synchronization with the downlink transmissions from the base station.

Clause 17. The UE of clause 16, wherein the transceiver is further configured so that the second shallow scan is responsive to the deep scan not being successful.
Clause 18. The UE of clause 16, wherein the transceiver is further configured so that the second shallow scan is subsequent to the first shallow scan, and so that the deep scan is further responsive to the second shallow scan not being successful.
Clause 19. The UE of any of clauses 15-18, wherein the synchronization signal is a synchronization signal block (SSB) for a new radio (NR) system.
Clause 20. The UE of any of clauses 15-19, wherein the first signal quality is a first signal-to-noise ratio, and wherein the second signal quality is a second signal-to-noise ratio.
Clause 21. The UE of any of clauses 15-20, wherein the transceiver is further configured to:

increment a count in a counter for the first shallow scan and again for the deep scan, wherein the first shallow scan is responsive to the count having a first value and wherein the deep scan is further responsive to the count having a second value.

Clause 22. The UE of clause 21, wherein the counter in a modulo-N counter.
Clause 23. The UE of clause 22, wherein the modulo-N counter is a modulo-4 counter.
Clause 24. The UE of clause 23, wherein the transceiver is further configured so that the deep scan is further responsive to the count for the modulo-4 counter equaling two.
Clause 25. A method of wireless communication, comprising:

incrementing a count;

responsive to the count being equal to a first integer, accumulating a received signal quality over multiple synchronization signal periods at each frequency of a synchronization raster to form an accumulated signal quality for each frequency;

determining if the accumulated signal quality for each frequency exceeds a first threshold to determine whether a synchronization signal is successfully detected at the frequency;

responsive to the count not being equal to the first integer, determining a received signal quality for an additional synchronization period at each frequency of a synchronization raster to form a received signal quality for each frequency; and

determining if the received signal quality for each frequency exceeds a second threshold to determine whether the synchronization signal is successfully detected at the frequency.

Clause 26. The method of clause 25, wherein incrementing the count comprises incrementing the count in a modulo-N counter.
Clause 27. The method of clause 26, wherein incrementing the count comprises incrementing the count in a the modulo-4 counter.
Clause 28. The method of any of clauses 25-27, wherein the first integer is two.
Clause 29. The method of any of clauses 25-28, wherein the synchronization signal is a synchronization signal block (SSB) for a NR radio system.
Clause 30. The method of any of clauses 25-29, wherein the accumulated signal quality and the received signal quality each comprises a signal-to-noise ratio.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method of wireless communication, comprising:
performing a first shallow scan at a user equipment over a frequency band by determining at each frequency of a synchronization raster for the frequency band whether a synchronization signal is received over a repetition period for the synchronization signal with a first signal quality to permit synchronization with a base station; and
in response to the first shallow scan not being successful, performing a deep scan over the frequency band by determining at each frequency of the synchronization raster for the frequency band whether the synchronization signal is received over a series of repetition periods for the synchronization signal with a second sufficient signal quality to permit synchronization with the base station.

2. The method of claim 1, further comprising:
performing a second shallow scan at the user equipment by determining at each frequency of the synchronization raster whether the synchronization signal is received over the repetition period for the synchronization signal with the first sufficient signal quality to permit synchronization with the base station.

3. The method of claim 2, wherein the second shallow scan is responsive to the deep scan not being successful.

4. The method of claim 2, wherein the second shallow scan is subsequent to the first shallow scan, and wherein the deep scan is further responsive to the second shallow scan not being successful.

5. The method of claim 1, wherein the synchronization signal is a synchronization signal block (SSB) for a new radio (NR) system.

6. The method of claim 5, wherein the first sufficient signal quality is a first signal-to-noise ratio, and wherein the second sufficient signal quality is a second signal-to-noise ratio.

7. The method of claim 6, wherein the first signal-to-noise ratio and the second signal-to-noise ratio are both measures of a primary synchronization signal (PSS) for the SSB.

8. The method of claim 6, wherein the first signal-to-noise ratio and the second signal-to-noise ratio are both measures of a secondary synchronization signal (SSS) for the SSB.

9. The method of claim 6, wherein the first signal-to-noise ratio and the second signal-to-noise ratio are both measures of a physical broadcast channel (PBCH) signal for the SSB.

10. The method of claim 9, wherein both measures are of a demodulation reference signal (DMRS) in the PBCH signal.

11. The method of claim 1, further comprising:
incrementing a count for the first shallow scan and for the deep scan, wherein the first shallow scan is responsive to the count having a first value and wherein the deep scan is further responsive to the count having a second value.

12. The method of claim 11, wherein incrementing the count comprises incrementing the count in a modulo-N counter.

13. The method of claim 12, wherein the modulo-N counter is a modulo-4 counter.

14. The method of claim 13, wherein the deep scan is further responsive to the count for the modulo-4 counter equaling two.

15. A user equipment, comprising:
a transceiver configured to:
perform a first shallow scan over a frequency band by a determination at each frequency of a synchronization raster for the frequency band of whether a synchronization signal is received over a repetition period for the synchronization signal with a first sufficient signal quality to permit synchronization with a base station; and
in response to the first shallow scan not being successful, perform a deep scan over the frequency band by a determination at each frequency of the synchronization raster of whether the synchronization signal is received over a series of repetition periods for the synchronization signal with a second sufficient signal quality to permit synchronization with the base station.

16. The user equipment of claim 15, wherein the transceiver is further configured to:
perform a second shallow scan over the frequency band by a determination at each frequency of the synchronization raster of whether the synchronization signal is received over the repetition period for the synchronization signal with the first sufficient signal quality to permit synchronization with the base station.

17. The user equipment of claim 16, wherein the transceiver is further configured so that the second shallow scan is responsive to the deep scan not being successful.

18. The user equipment of claim 16, wherein the transceiver is further configured so that the second shallow scan is subsequent to the first shallow scan, and so that the deep scan is further responsive to the second shallow scan not being successful.

19. The user equipment of claim 15, wherein the synchronization signal is a synchronization signal block (SSB) for a new radio (NR) system.

20. The user equipment of claim 19, wherein the first sufficient signal quality is a first signal-to-noise ratio, and wherein the second sufficient signal quality is a second signal-to-noise ratio.

21. The user equipment of claim 15, wherein the transceiver is further configured to:
increment a count in a counter for the first shallow scan and again for the deep scan, wherein the first shallow scan is responsive to the count having a first value and wherein the deep scan is further responsive to the count having a second value.

22. The user equipment of claim 21, wherein the counter in a modulo-N counter.

23. The user equipment of claim 22, wherein the modulo-N counter is a modulo-4 counter.

24. The user equipment of claim 23, wherein the transceiver is further configured so that the deep scan is further responsive to the count for the modulo-4 counter equaling two.

25. A method of wireless communication, comprising:
incrementing a count;
responsive to the count being equal to a first integer, accumulating a received signal quality over multiple synchronization signal periods at each frequency of a synchronization raster to form an accumulated signal quality for each frequency;
determining if the accumulated signal quality for each frequency exceeds a first threshold to determine whether a synchronization signal is successfully detected at the frequency;
responsive to the count not being equal to the first integer, determining a received signal quality for an additional synchronization period at each frequency of a synchronization raster to form a received signal quality for each frequency; and
determining if the received signal quality for each frequency exceeds a second threshold to determine whether the synchronization signal is successfully detected at the frequency.

26. The method of claim 25, wherein incrementing the count comprises incrementing the count in a modulo-N counter.

27. The method of claim 26, wherein incrementing the count comprises incrementing the count in a modulo-4 counter.

28. The method of claim 27, wherein the first integer is two.

29. The method of claim 25, wherein the synchronization signal is a synchronization signal block (SSB) for a NR radio system.

30. The method of claim 25, wherein the accumulated signal quality and the received signal quality each comprises a signal-to-noise ratio.
